(19) United States
(12) Patent Application Publication
(10) Pub. No.: US 2019/0161367 A1
(43) Pub. Date: May 30, 2019

(54) ROTATIONALLY SYMMETRIC PHOTOANALYTIC REACTOR FOR WATER PURIFICATION

(71) Applicant: OREGON STATE BOARD OF HIGHER EDUCATION ON BEHALF OF PORTLAND STATE UNIVERSITY, Portland, OR (US)

(72) Inventors: Simon Fowler, Portland, OR (US); Jun Jiao, Portland, OR (US); Ryan Catabay, Portland, OR (US)

(73) Assignee: Portland State University, Portland, OR (US)

(21) Appl. No.: 16/092,755

(22) PCT Filed: Apr. 14, 2017
(86) PCT No.: PCT/US2017/027784

§ 371 Date: Oct. 10, 2018

Related U.S. Application Data
(60) Provisional application No. 62/322,484, filed on Apr. 14, 2016.

(51) Int. Cl. C02F 1/32; C02F 1/72

(52) U.S. Cl. CPC C02F 1/325; C02F 1/725; C02F 2305/10; C02F 2201/3227; C02F 2201/3222

(57) ABSTRACT

Devices, systems, and methods for the purification of water with a photoreactor. A continuous flow water purification photoreactor having a water inlet, a plurality of illumination sources disposed about a central axis facing and having n-fold rotational symmetry about the central axis, a reaction tube, and a water outlet. The reaction tube including a set of bundled rods having m×n-fold symmetry wherein the bundled rods include a photocatalyst support material at least partially coated with a photocatalyst film.

### CROSS-REFERENCE TO RELATED APPLICATION

This application claims the priority benefit of the earlier filing date of U.S. Provisional Application No. 62/322,484, filed Apr. 14, 2016, which is specifically incorporated herein by reference in its entirety.

### TECHNICAL FIELD

Embodiments relate to water purification and specifically to a reactor for purifying water through photocatalytic degradation of pollutants.

### BACKGROUND

In a study conducted by the Environmental Working Group, a non-profit water quality research group, an analysis was conducted on almost 20 million records obtained from state water officials. The study found 316 different pollutants in the drinking water from 45 states. Only about one third of the chemicals they found in the water supply are regulated by the EPA for health and environmental impact, despite the fact that health standards have been set for these unregulated chemicals. Many of these chemicals are organic molecules introduced into the water supply system from pesticides, pharmaceuticals, industrial byproducts, and urban runoff.

Typical water treatment facilities in the US remove between 85% and 95% of organic contaminants from the waste stream using what are known as primary and secondary treatment processes. The effluent, which is the water after being treated by the facility, is often discarded to rivers and lakes, along with the remaining 5%-15% of pollutants. However many sites now include an additional tertiary treatment phase, utilizing ultraviolet (UV) irradiation to destroy the pathogens in this effluent, so that it can be reclaimed for other purposes, rather than discarded. Although this technique has been successful on many levels, it is possible to improve upon this system to create solutions for the anticipated water demands of the future.

UV light is an effective water treatment for killing pathogens through inactivation of the organisms' ability to reproduce and is one the four methods of disinfection approved by the United States FDA. UV light with a wavelength of 200-300 nm is absorbed by the nucleotides within the DNA living organisms, impairing their ability to reproduce. However, UV light does not have much effect on the vast majority of organic substances.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 is a schematic overview of a photoreactor geometry, in accordance with embodiments disclosed herein.

FIG. 2 is a schematic overview of a photocatalyst cartridge, in accordance with embodiments disclosed herein.

FIG. 3 is a schematic of a rod cross section, in accordance with embodiments disclosed herein.

FIGS. 4A and 4B are a set of traces showing optical emission and absorption properties, in accordance with embodiments disclosed herein.

FIGS. 5A-5D are a set of schematics showing rotational symmetry, in accordance with embodiments disclosed herein.

FIG. 6 is a schematic of a photoreactor cross section showing illumination portioning, in accordance with embodiments disclosed herein.

FIGS. 7A and 7B are a set of schematics showing that photoreactor geometry results in the absence of optical holes, in accordance with embodiments disclosed herein.

FIG. 8 is a schematic showing an off axis view with an optical hole in the photocatalyst bundle shown, in accordance with embodiments disclosed herein.

FIGS. 9A and 9B are digital images of working embodiments of a photoreactor.

FIG. 10 is schematic of a 3D photocatalyst material showing the general shape of the material and the way in which water flows through the material as it enters and exits the reaction chamber, in accordance with embodiments disclosed herein.

FIG. 11 shows a schematic depiction of photon penetration of a a thin-film catalyst.

FIG. 12 shows a schematic depiction of an experimental setup to optimize catalyst thickness.

FIG. 13 shows a schematic depiction of an experimental setup to optimize catalyst thickness.

FIG. 14 shows a set of SEM images of coated slides.

FIGS. 15A and 15B are a LED emission spectrum and a curve showing TiO₂ penetration depth of 365 nm light (peak emission value).

FIGS. 16A and 16B are UV-Vis reference spectrums from 200-700 nm were collected for Methylene Blue and TiO₂ coated slide.

FIGS. 17A and 17B are graphs of a normalized absorption spectrum time series and a Methylene Blue decay curve as a function of time.

FIG. 18 is a set of equations used for predicting Quantum Yield.

FIG. 19 is a graph and equation used to quantify the Quantum Yield (Q) as a function of thickness.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

An expanding human population coupled with increased dependence on industrial activities is rapidly producing fresh water shortages, and simultaneously causing the devastation of natural habitats throughout the world. As a result, there is increased demand for clean water and more stringent governmental regulation of wastewater. Together, this creates not only an environmental issue but also an economic issue. An economic analysis titled Charting our Water Future was published in 2009 by the 2030 Water Resources Group to predict the financial future of water over the next 20 years. Their assessment was that due to increases in population, water intensive processes and an increasing difficulty in removing anthropogenic pollutants, water demand will increase by 40% in the next 20 years. For these reasons, water treatment effluent is increasingly being recognized as an important water resource, and so water reclamation through the use of tertiary UV treatment is expected to increase.

Advanced Oxidation Processes (AOP) are a category of processes that break down the chemical bonds of the harmful organic molecules present in water (e.g. bacteria, viruses, hormones, pharmaceuticals, etc.) thereby converting these pollutants into relatively benign molecules through oxidative degradation. This allows for the purification of organics without the need of chemical additives and without the need to remove, and thus concentrate, the pollutants. The specific AOP being employed in the system, devices and methods disclosed herein is technically referred to as semiconductor photocatalysis, which has many advantageous qualities: 1) it utilizes a semiconducting photocatalyst material to absorb the energy required for the oxidation reaction from light; 2) the photocatalyst material is not consumed during the reaction; 3) the photocatalyst lowers the amount of energy needed for the oxidation reaction; 4) the process breaks down pollutants using oxidative degradation, and therefore does not produce hazardous wastes. The end result of this process is mineralization of the organics into benign and stable molecules.

As disclosed herein, the inventors have improved tertiary water treatment by designing a novel photoreactor with specific geometric constraints that provide for more efficient water purification. For the end user of this process an increased level of purification leads to an increase in demand, and thus value of the effluent. Thus the disclosed systems, devices, and methods provide an economic advantage over systems that without this capability.

In addition, it is very likely that the organic pollutants themselves have intrinsic value. Typically the products of the AOP reaction are water soluble mineral acids, water, and CO₂ gas. In fact, it is possible for the exhausted CO₂ gas from the oxidation reaction to be harvested as raw material. For example Bayer™ claims to have been using CO₂ gas exhausted from chemical reactions to synthesize polyurethane foam since 2011. This means that it is possible for the carbonaceous organic species that are polluting the water to be converted, by the photocatalyst, into gaseous CO₂ and harvested as a raw material for the production of plastics. Thus even the problematic organic compounds that are currently difficult and expensive to get rid of will acquire value. The possibility of turning a waste product into a raw material is a huge benefit to end users of the disclosed water purification system.

The mechanism employed in the disclosed systems, devices and methods is known as semiconductor photocatalysis. It uses a process similar to that of a solar cell, in which photons are absorbed by semiconducting material and converted into free electrons. However, instead of storing this energy as a voltage, the process of photocatalysis uses this energy to convert H₂O molecules into OH. molecules.

A primary example of a photocatalyst material is titanium dioxide (TiO₂), which is an extremely strong candidate for scalable use because of its light absorption properties, stability in water, biocompatibility, abundance, and low cost. When illuminated with UV light, TiO₂ catalyzes the production of hydroxyl radicals (OH.), which are charge neutral particles that oxidize complex molecules to form more stable and inert minerals. The hydroxyl radicals themselves are unstable, so they quickly decay back into water once the water exits the reaction chamber; therefore the process breaks down pollutants without leaving a residual in the water. The overall result, then, is a more advanced and effective water purification process that does not rely upon the addition of chemicals into the water, and yet is more capable of breaking down pollutants than current technology. Through the addition of a photocatalyst material into a portion of a reaction chamber, UV light is absorbed by the photocatalyst material and converted into a form of chemical energy, resulting in the oxidation of substances dissolved or suspended in the water. Of particular importance, oxidation has the ability to break down organic molecules that have potentially hazardous effects on the environment or living systems. This simple addition of photocatalyst thus converts a single stage UV disinfection system into a two stage disinfection and purification system.

Despite the numerous benefits of photocatalytic water purification, transitions from laboratory results to full scale implementation have been a slow moving process. It is quite reasonable to believe that this lag is due to the incredibly challenging and interdisciplinary nature of the problem. The implementation of a technology of this kind requires not only multidisciplinary knowledge, but also extraordinary engineering creativity in order to integrate the various disciplines without compromising the qualities of each individual part of the system. One important consideration is that the entire process, from beginning to end—light illumination to pollutant degradation—is quite complex and can be influenced by many different factors. There are several aspects of the degradation reaction that require seemingly contradictory qualities in the reaction system. This leads to scattered development of efficient photocatalyst materials. For instance, one of the most crucial factors for obtaining high reaction rates is a high ratio of catalytic surface area to water volume. This leads many research groups towards reactors that involve suspensions of photocatalyst nanoparticles, known as slurry reactors. These are often favorable for research publications because they produce fast degradation rates. However these systems cannot be operated under continuous flow conditions because they introduce the daunting difficulty of removing the nanoparticles before the water can be considered clean. On the other hand, while fixed photocatalyst systems allows for continuous flow operation, they typically suffer from slow reaction rates due to limited photocatalyst surface area and poor mass transfer rates.

One point of novelty of the disclosed methods, devices, and systems is that they maintain all necessary attributes for efficient degradation conditions and effectively solve the major problems that have thus far prevented successful implementation. The chamber where the purification takes place is referred to as a photoreactor, and it is designed with great emphasis on the geometry, composition and morphology of the materials used to build it in order to ensure UV light can permeate the reaction chamber with no shadows or strong light intensity gradients. These illumination chambers have been well optimized for UV photocatalytic systems disclosed herein.

Disclosed herein in is a device for use in water purification via photocatalytic degradation of pollutants. Water purification is accomplished by passing water, such as water including or suspected of including contaminants through a disclosed photoreactor. In embodiments, a photoreactor includes at least a light source and a photocatalytic material, for example a photocatalytic material that is activated by the light source. For purification, such as treatment or conditioning, the water is brought into contact with the surface of the photocatalyst while the surface is being illuminated by an appropriate wavelength of light. The photocatalyst material absorbs the light and converts it into an electronic form of energy that is then converted to chemical energy at the photocatalyst-water interface. The result of this process is the chemical oxidation of suspended pollutants. Disclosed herein is a device, such as a photoreactor, that makes this process highly efficient. Several unique aspects of this photoreactor provide for superior performance. Among these features is the implementation of the photocatalyst material in the form of a reusable cartridge that can be cleaned and replaced if the catalytic surface becomes fouled. This feature allows for replacement of the cartridge rather than the entire unit resulting in lower overall cost to the end user. In addition, the unique symmetrical correspondence between the geometry of the illumination system and photocatalyst material provides for enhanced catalysis with minimal space and material use, further reducing the cost an end user. Furthermore, the three-dimensional (3D) structural design of the photocatalyst material minimizes energy loss from the optical system.

Disclosed is a continuous flow water purification photoreactor. In embodiments, the continuous flow water purification photoreactor includes: a water inlet; a plurality of illumination sources disposed about a central axis; a reaction tube having a set of bundled rods with photocatalyst support material at least partially coated with a photocatalyst film; and a water outlet. The water inlet is fluidly coupled to a proximal end of the reaction tube and the water outlet is fluidly coupled to a distal end of the reaction tube. In embodiments, the illumination sources face the central axis and have n-fold rotational symmetry about the central axis, where n is a whole number. In embodiments, the set of bundled rods in the reaction tube have m×n-fold symmetry, where m is a rational number. In embodiments, the continuous flow water purification photoreactor includes a housing, for example for mounting the reaction tube and/or the illumination sources. In embodiments, the illumination sources are LEDs emitting in the UV range.

For the purposes of promoting an understanding of the principles of the disclosure, reference will now be made to the embodiments illustrated in the drawings and specific language will be used to describe the same. It will nevertheless be understood that no limitation of the scope of the claims is thereby intended. Any such alterations and further modifications in the illustrated device, and any such further applications of the principles as illustrated herein, are contemplated as would normally occur to one skilled in the art to which the disclosure relates.

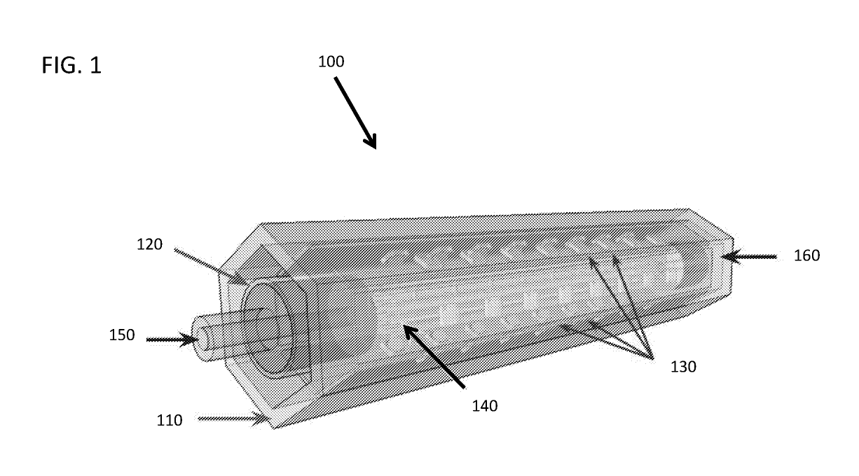

An embodiment of a disclosed device is shown in FIG. 1. An assembled photoreactor 100 includes a photoreactor housing 110, disposed about a reaction tube 120. Also within the photoreactor housing 110, but exterior to the reaction tube 120 are light sources 130, such as LED illuminators positioned about the reaction tube 120 so as to provide illumination to a photocatalyst material 140 contained within the reaction tube 120. As shown in FIG. 1, the photoreactor 100 also includes a water inlet 150 and a water outlet 160. The water inlet 150 can be connected to a water source, such a water source having, or suspected of having contaminated water. The water outlet 160 can be connected or coupled to any output, for example a storage tank, spigot, or any other system or subsystem where clean and/or processed water is desired. It is intended that the device to be used in continuous flow operation. For example, contaminated water flows into the reaction tube 120 through the water inlet 150, also referred to herein as an inlet port. The water then flows across the surface of an illuminated photocatalyst material 140, and then exits through the water outlet 160. Molecules that are dissolved or otherwise carried in the water are oxidized by an Advanced Oxidation Process (AOP) as they pass through the reaction tube.

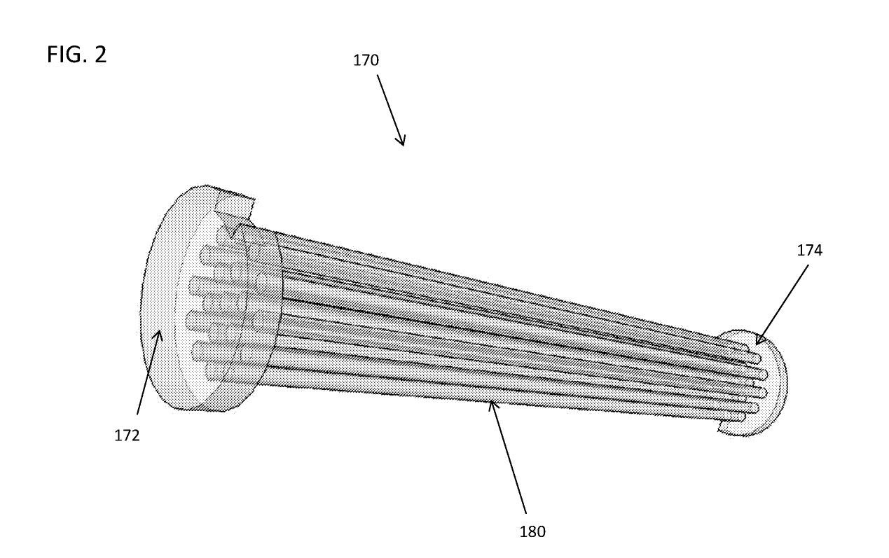

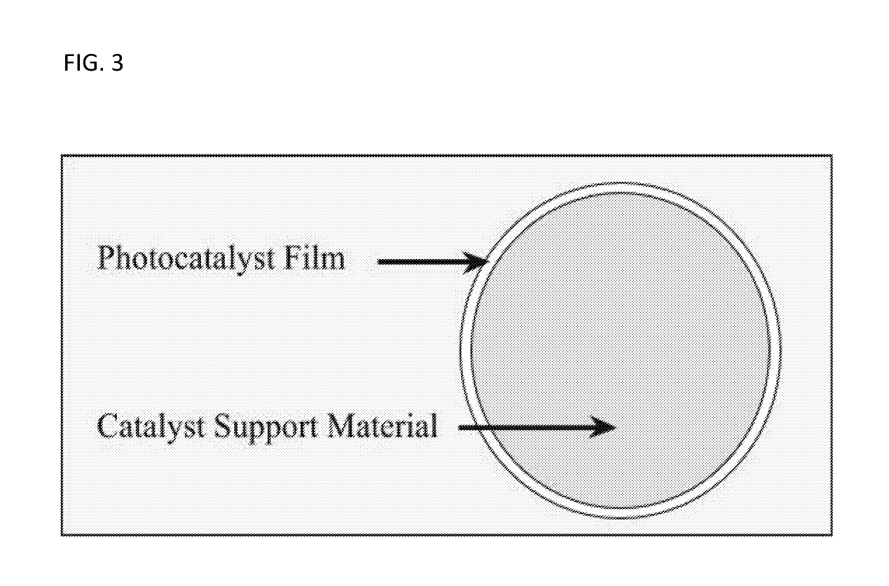

In embodiments, the photoreactor is designed to use a photocatalyst cartridge that is optimized for system efficiency, as well as be removable and cleanable. An embodiment of a photocatalyst cartridge 170 is shown in FIG. 2. As shown in FIG. 2, the photocatalyst cartridge 170 includes a proximal end 172 and a distal end 174 that, in some embodiments, can be interchangeable (for example reversible), and a set of rods, or a rod bundle 180, disposed between the proximal end 172 and the distal end 174. The rod bundle 180 includes both a photocatalyst support and photocatalyst coating disposed upon the 3D surface of the photocatalyst support. In embodiments, the photocatalyst material itself is highly absorptive of the light from the light source, for example a UV light source. Thus, its shape and quantity are important aspects of the photocatalyst cartridge 170 design. It addition, photocatalysts are typically brittle materials that can be easily destroyed by water pressure and flow. For these reasons, the photocatalyst cartridge 170 is typically a composite material including a 3D photocatalyst support that has been coated with a thin film of the photocatalyst, see for example FIG. 3. In addition, the shape of the rod bundle 180 is selected to minimize water pressure on film surface, improving the lifetime of the photocatalyst film, for example by preventing, or reducing, film cracking and flaking.

As disclosed, the photocatalyst support is a rigid material in the shape of a rod or a multitude of rods, such as a rod bundle, providing the shape, strength and durability of the cartridge. The thin film of photocatalyst material thus takes on the same 3D shape as the support material. A cross section of one of the rods in the bundle is shown in FIG. 3. In embodiments, the thickness of the photocatalyst film is optimized to provide the maximum quantum yield for the degradation reaction. Films that are too thick create strong light gradients that are undesirable, decreasing uniformity of the light distribution within the photoreactor. If however the films are too thin, there will not be enough photocatalyst to absorb all of the light. This decreases the overall efficiency of the photoreactor as UV light that is transmitted through the photocatalyst and will likely just be absorbed by the photoreactor housing.

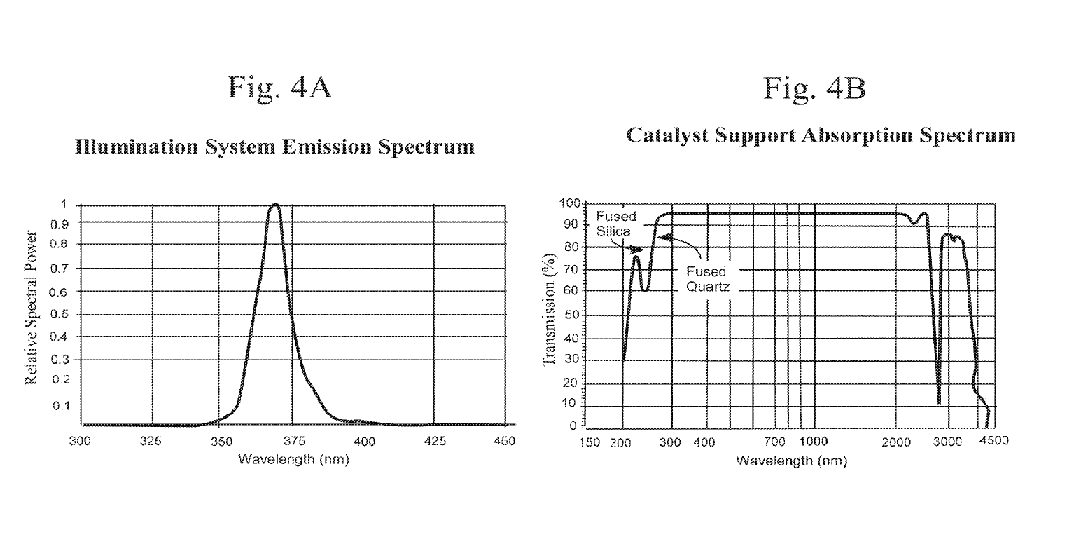

Because the photocatalyst support material does not take part in the catalysis reaction it is selected to be as transparent as possible to the wavelengths of light given off by the light source, such as LED emitters emitting light in the UV range. By selecting a photocatalyst support with this property, the disclosed photoreactor has the effect of minimizing the parasitic absorption by the support. In other words, this ensures that the photocatalyst support does not create optical shadows within the reaction chamber. For example, for the LEDs with an emission peak at 365 nm, as shown in FIG. 4A, a support material that is transparent to the wavelengths from 350 to 400 nm should be chosen. FIG. 4B shows that either Fused Silica or Fused Quartz would be a good choice for this case.

In selecting an appropriate photocatalyst support material several other properties can be considered. For example:

the material should be heat stable to allow for photocatalyst heat treatment during fabrication and cleaning:

the material should be chemically stable to prevent interaction with photocatalyst;

be an electrical insulator to prevent energy loss during photocatalysis;

the material should be photostable for very long time periods under intense UV illumination;

the material should be incompressible under systems operational water pressure. Quartz is an example of a material that possess all of these properties. Thus in embodiments, the photocatalyst support material includes quartz.

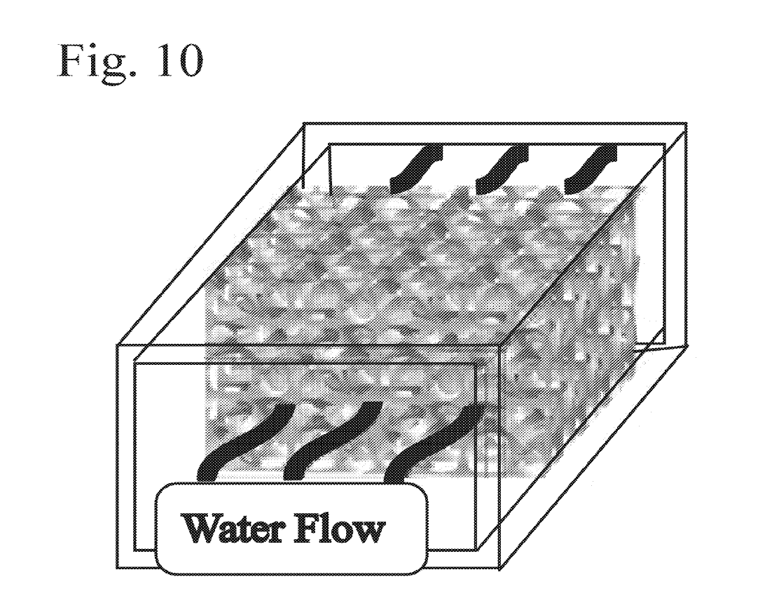

In embodiments a photocatalyst comprises one or more of and oxide of Ti, Zn, Zr, Sn, W, and/or Ga. In embodiments, a photocatalyst comprises TiO₂. In some embodiments, a photocatalyst comprises a thin coating over the surface of photocatalyst support material. In some embodiments the thin coating is between about 5 nm to microns and about 10 μm in thickness, such as about 5 nm, 10 nm, 20 nm, 30 nm, 50 nm, 60 nm, 70 nm, 80 nm, 90 nm, 100 nm, 110 nm, 125 nm, 150 nm, 175 nm, 200 nm, 300 nm, 400 nm, 500 nm, 600 nm, 700 nm, 800 nm, 900 nm, 1.0 μm, 2.0 μm, 3.0 μm, 4.0 μm, 5.0 μm, 6.0 μm, 7.0 μm, 8.0 μm, 9.0 μm, or 10.0 μm or any range therein. In some embodiments the photocatalyst support material comprises quartz and/or fused silica. In some embodiments, a thin ceramic coating of TiO₂ (catalyst) forms a film on the surface of the 3D quartz structure. In some embodiments the photocatalyst support material comprises quartz and/or fused silica. In some embodiments the photocatalyst support material is porous allowing water to pass through. In some embodiments, improved light distribution conditions inside a bioreactor creating high intensity, low gradient conditions is accomplished through the use of a high-porosity glass photoreactor medium, such as high-porosity fused-silica glass (SiO₂), which is very strong, highly UV transparent, biocompatible, inexpensive and abundant (see for example FIG. 10). Thus in some embodiments, the photocatalyst support material includes high-porosity fused-silica glass (SiO₂). In some embodiments, a thin ceramic coating of TiO₂ (catalyst) forms a film on the surface of the 3D silica structure.

A photocatalyst cartridge can be fitted into a portion of the reaction chamber of a UV disinfection system, thus allowing photocatalytic degradation and pathogen disinfection to take place within the same system. In some embodiments, the photocatalyst support material has a 3D reticulated (open-pore) geometry. The material can be described as a solid, transparent, high surface area, photoreactor medium.

Exemplary methods of fabrication of the photocatalyst are described below. Fabrication typically includes two general synthesis steps: 1) creation of photocatalyst support material, such as reticulated silica structure, to act as the photocatalyst support; 2) modification of the photocatalyst support material with a thin photocatalyst coating, such as a ceramic TiO₂ coating. With respect to the reticulated silica structure, the photocatalyst support material has a 3D mesh shape, as shown in FIG. 10. The structure and composition of the material are factors for consideration. There are two physical characteristics that this material has: 1) the material has a reticulated, or open-pore, morphology; and 2) it consists of a highly UV-transparent photocatalyst support material modified by a thin ceramic titania coating. The resulting material as scalable and shapeable, which means that it can easily accommodate nearly any geometry that a particular photoreactor requires. The reticulated structure allows the water to be constantly mixed as it flows through the photoreactor chamber, while also providing an extremely high ratio of catalytic surface area to volume of contaminated water. The geometry of the structure provides good mass transfer to the catalytic surface while the water passes through the system, which improves reaction kinetics. The high surface area to volume ratio—provided by the fused silica support structure—is also highly transmissive in the UV range (so it does not parasitically absorb UV photons), which allows nearly all usable photons to be absorbed by the coating of TiO₂ at the material surface. This creates a very high quantum yield, i.e. conversion ratio of incoming photons to OH. molecules, which is directly related to the concentration of oxidizing molecules inside the photoreactor.

In embodiments, this material has a fused silica (SiO₂) photocatalyst support and a thin layer of polycrystalline titania (TiO₂) present in an atomic mixture of anatase and rutile phases. It has a rigid 3D structure that is ideal for systems that aim to purify water in a continuous flow operation (i.e. not a batch type system), which is typically the case for commercial and industrial applications. The material can be controlled in terms of its reticulation porosity (pores/inch) crystallinity and photocatalyst layer thickness. The crystallinity should ideally be a high percentage (60-80%) anatase and a relatively lower percentage (20-40%) rutile. Although pure anatase is a better photocatalyst than pure rutile, the most effective material consists of atomically mixed polyphase titania that can be synthesized in bulk using flame pyrolysis.

In some embodiments, the light source includes LEDs, such as LEDs emitting light in the UV spectrum. The use of LEDs has advantages over standard mercury bulbs. For example, the use of LEDs gives complete geometric control over the illumination geometry, whereas bulb type emitters require the use of mirrors to direct the light, which is limited and inefficient. In addition, LED emitters allows the choice of a particular wavelength of light that is most efficient for the reaction. The ideal wavelength depends on the specific materials used for the photocatalyst and photocatalyst support. Lastly, the efficiency of the process for generating light from electricity is better for LEDs than for mercury bulbs, and continues to improve as the technology evolves.

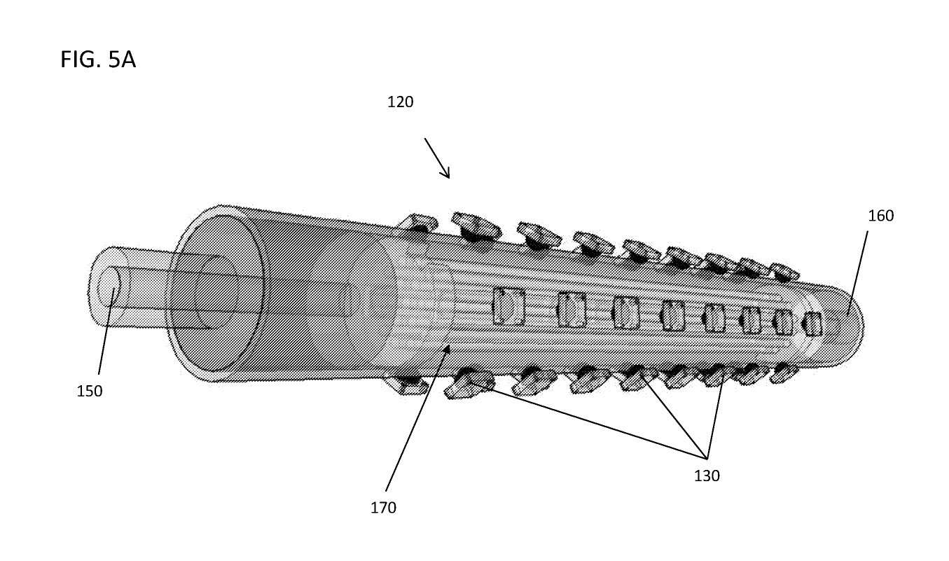

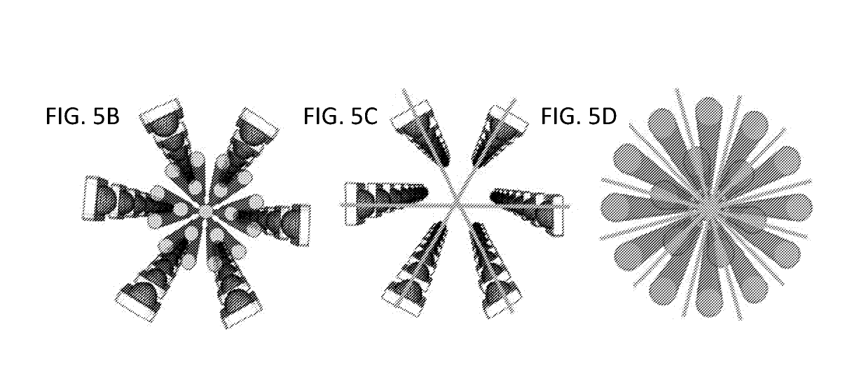

As disclosed herein the device for use in water purification via photocatalytic degradation of pollutants has a specific geometry that maximizes efficiency. This geometrical design is the implementation of a correspondence between the rotational symmetry of the illumination system and the catalyst material (see for example FIG. 5B). This combination improves conversion efficiency of UV photons to oxidative species. Specifically, the Illumination/photocatalyst system is symmetrically aligned such that: the arrangement of Ultraviolet (UV) emitters has a degree of cylindrical symmetry; the LEDs focus on the axis of symmetry for the system; the geometrical shape of the photocatalyst has a degree of rotational symmetry that matches that on the illumination symmetry; and the center of photocatalyst material is at the focus of illumination.

In embodiments, the illumination/photocatalyst system is symmetrically aligned such that the illuminator has n-fold symmetry and the photocatalyst has m×n-fold symmetry, where m is a rational number. The photocatalyst material is supported by a rigid material that is transparent to light of same frequency that is utilized to power the photocatalytic reaction. The center of photocatalyst material is also the center of the illumination system. The photocatalyst-support material has a rigid 3-dimensional structure. The photocatalyst and photocatalyst-support structure has a geometric shape designed to maintain even light distribution across all photocatalytic surface.

In the schematic illustration shown in FIGS. 5A-5D, the embodiment shown has six UV-LED strips that are arranged into a hexagonal tube that surrounds the reaction chamber, giving the illumination geometry 6-fold rotational symmetry (FIG. 5C). This aligns with the rotational symmetry of the photocatalyst material that is inside the reaction tube. The photocatalyst material is disposed on a bundle of 19 rods arranged such that there are 12 rods in a circular pattern circumscribing a second ring of 6 rods, and finally containing a single rod at the center. The resulting structure has 12-fold rotational symmetry (FIG. 5D). Therefore, with the LED strips and the photocatalyst bundle properly aligned, the entire system shares a 6-fold rotational symmetry. FIG. 5A shows a reaction tube 120 with light sources 130, such as LED illuminators positioned about the reaction tube 120 so as to provide illumination to a photocatalyst material contained within the photocatalyst cartridge 170. As shown in FIG. 1, the photoreactor 100 also includes a water inlet 150 and a water outlet 160. The water inlet 150 can be connected to a water source, such a water source having, or suspected of having contaminated water. FIGS. 5B-5D depict the rotational symmetry of the system as viewed end on.

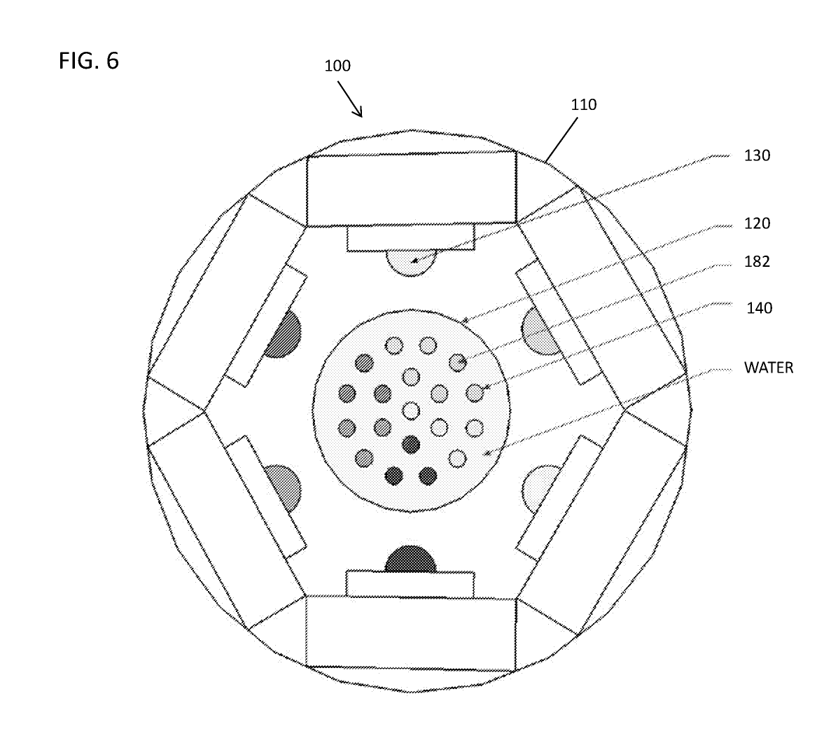

In understanding the rotational symmetry, it is useful to imagine grouping the bundle accordingly, so that it is divided into 6 sections corresponding to the 6-fold symmetry of the system (FIG. 6). Each section contains an equal portion of the rods. And no individual rods are shadowed from the LED strip that is dedicated to its section. The central rod, though heavily shadowed, will still receive significant light intensity since it is located at the focus, and will receive a large amount of both scattered and transmitted light. Additionally, its inclusion does not break the 6-fold symmetry of the system, despite the fact that it does not distinctly lie in any particular section. As shown in FIG. 6 there is rotational 6-fold symmetry about the central rod. As shown in FIG. 6 an assembled photoreactor 100 includes a photoreactor housing 110, disposed about a UV transparent reaction tube 120. Also within the photoreactor housing 110, but exterior to the reaction tube are light sources 130, such as LED illuminators positioned about the reaction tube 120 so as to provide illumination to a photocatalyst material 140 contained within the reaction tube 120 and disposed on a rod 182, such as a UV transparent rod. As shown in FIG. 6, the water passes through the reaction tube 120, where it then flows across the surface of an illuminated photocatalyst material 140. Molecules that are dissolved or otherwise carried in the water are oxidized by an Advanced Oxidation Process (AOP) as they pass through the reaction tube.

The purpose of the symmetrical design is to maintain even light distribution across all photocatalytic surfaces, allowing the photoreactor to operate at its maximum efficiency. This is because the efficiency of the photocatalytic reaction is actually a composite of the efficiencies of the individual constituents of the reaction.

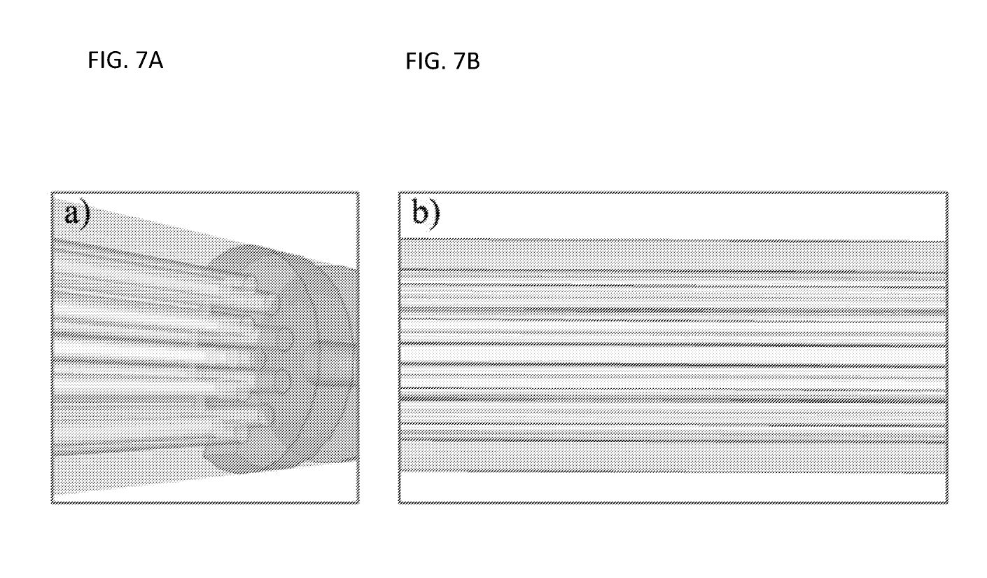

Another very important quality of the photocatalyst bundle is that its geometrical shape does not contain any direct optical paths from the emission point of any LED through the catalyst bundle, such that the path does not intersect the surface of at least one rod. This design ensures that light is not passing through the bundle without interacting with the photocatalyst material, since any light that doesn't interact is wasted, causing a decrease in system efficiency. Careful examination of the images shown in FIGS. 7A and 7B helps to visualize this. FIG. 7A shows the catalyst bundle from a reference point on one of the lines of symmetry (where an LED would be located). The view is at an angle to give perspective of the rod arrangement, as the rod termination points on the end cap reveal the orientation. The image in FIG. 7B represents the perspective of a LED, where it can clearly be seen that from this perspective of the emission source, there are no holes in the catalyst material.

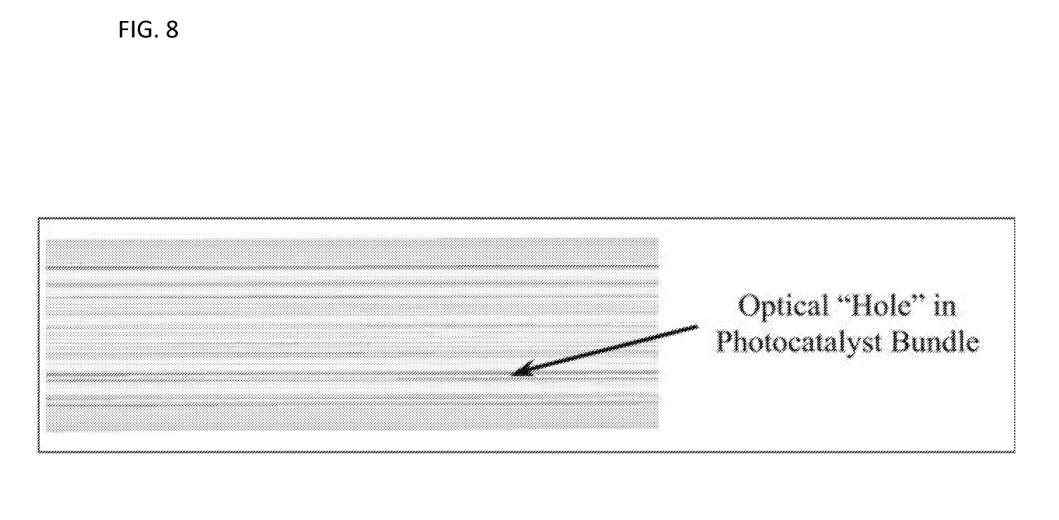

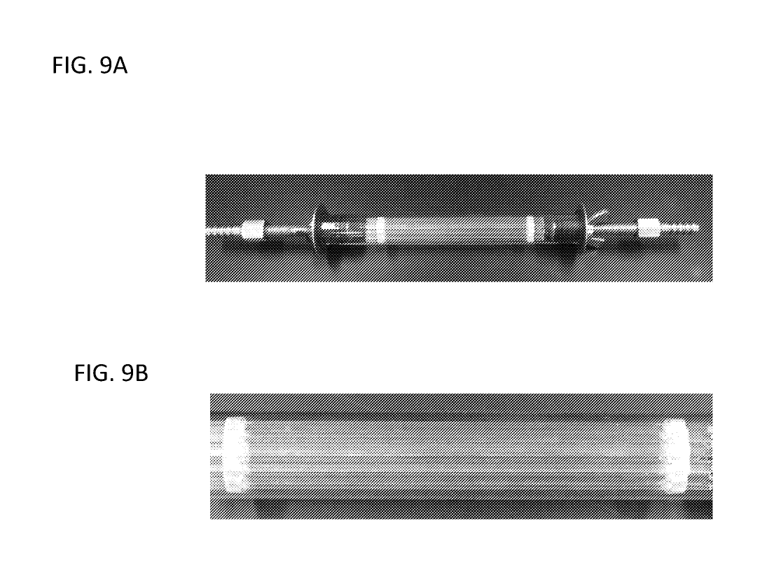

To clarify this point, FIG. 8 shows the photocatalyst bundle from an orientation that is not on one of the lines of symmetry. From this perspective it is clear there do exist optical paths, or “holes” in the catalyst bundle. If the LEDs were to be mounted at this angle, light would pass through these holes and likely be absorbed by the photoreactor housing, essentially causing a loss of energy and system efficiency. Yet the use of LEDs for the photoreactor provides a discrete set of illumination points, allowing these losses to be avoided.

### EXAMPLES

### Example 1

### Material Synthesis and Characterization

A lab scale photoreactor design is proposed and constructed to test the overall effectiveness of the material. Analysis is done on the physical and chemical properties that affect the pollutant degradation rate and the applicability of the material for commercial and industrial purposes.

Fabrication of the Catalytic Material

Fabrication of the material is pursued using three different approaches described below aimed at identifying an optimum procedure to produce a silica support structure. The process for coating the photocatalyst layer onto the fused silica produced by each different approach is nearly identical.

Method A: 3D Printing of a Silica Template

A sacrificial template for the mesh structure is printed using a 3D printer. This gives extremely fine control over the geometrical parameters of the mesh, resulting in simple variation of optical and fluid characteristics within the reaction chamber.

Method B: Reticulated Polymer Replication

The 3D mesh is fabricated using a polymer replication technique. This will result in a very fine mesh with very high surface area, theoretically yielding faster degradation of pollutants.

Method C: Construction from Prefabricated Fused Silica

Construction of 3D mesh may be carried out using prefabricated fused-silica rods, which are inexpensive and easily available. This option will likely be the simplest and most robust structure.

Characterization of Surface and Interface Properties

The photocatalyst surface and the photocatalyst-support interface is a characteristic of the material. Analysis of the interface is focus on the detection of Si—O—Ti at the interface, indicating strong chemical bonding of the two materials. Surface characterization is done using SEM, TEM, and BET.

Analysis of Optical Scattering and Absorption Properties

The optical properties of the material are most useful for determining the required density and porosity of the material for optimizing the UV intensity distribution within the reaction chamber. Verification of the TiO₂ absorption edge, and light scattering and absorption properties are measured using a UV-vis spectrophotometer.

Determination of Quantum Yield with and without Medium

The overall purpose of this material is to make efficient use of UV photons that enter the reaction chamber. For this purpose the quantum yield is defined as the ratio of incoming UV photons to the number of hydroxyl radicals formed in solution. Quantification of the quantum yield is done through measurement of the system oxidation potential.

Quantification of Water Purification Effectiveness

The most important quality of the resulting material is its effectiveness to remove organic contaminants from water. In order to quantify this a lab scale photoreactor system has been designed. This system allows for testing the rate of organic molecule degradation. Preliminary tests will use an organic marker, Methylene Blue (MB), which is added to clean water to represent an organic contaminant. A great advantage of this system, is that measurement is made in situ, while under continuous flow conditions. This means that information about the reaction is acquired instantly, and in conditions that are similar to those used in industrial systems.

The data collected from this system is analyzed in terms of its ability to perform catalytic degradation. This analysis will result in optimization of the material, correlation of the material properties with degradation results, and a comparison of the photocatalytic system to a commercially available UV system.

Empirical Optimization of Photocatalyst Material

In order to test the material's true effectiveness at water purification, the material should be tested inside a photoreactor under a continuous flow of polluted water. Isolation of degradation and adsorption mechanisms should also be done in order to quantify the material properties in a useful way. Initial testing of the purification effectiveness will first be done using lab scale variants of the material.

Correlation of Experimental Results with Material Properties

Once testing of the material properties is complete, a thorough analysis will be conducted in order to understand and isolate the relationships between distinct material properties (e.g. geometry and crystallinity) and the observed experimental results (e.g. optical scattering and oxidation potential).

Investigation of Commercial and Industrial Feasibility

In order to determine promise at the industrial level, an analysis of the system's ability to perform in existing commercial systems is performed. This is done by fabricating a photocatalyst cartridge that can be inserted into a commercially purchased UV sanitation system. Municipal waste samples are tested and purified in the modified commercial system.

Testing of Material Effectiveness in Commercial Scale System

Based on results from the lab scale photoreactor, fabrication of the photoreactor medium will begin for use in a commercially available UV disinfection system. A comparison of the system's effectiveness at organic pollutant degradation as well as pathogen disinfection will be compared with and without the photoreactor medium.

Testing of Municipal Water Samples

The final test for the photocatalyst system is to test its effectiveness on municipal water samples. This will require collaboration with Portland Water Bureau and will be aided by our group's current contacts within the American Water Works Association.

### Example 2

### Optimization of Photocatalytic Films for Water Purification

The photoreactor shown in FIG. 1 utilizes UV-LEDs which illuminate a reaction tube that is filled with a 3D photocatalyst medium designed to operate with a continuous flow of polluted water. The material uses a complex 3D structure provided by a quartz substrate coated with thin film of nano-particulate TiO₂.

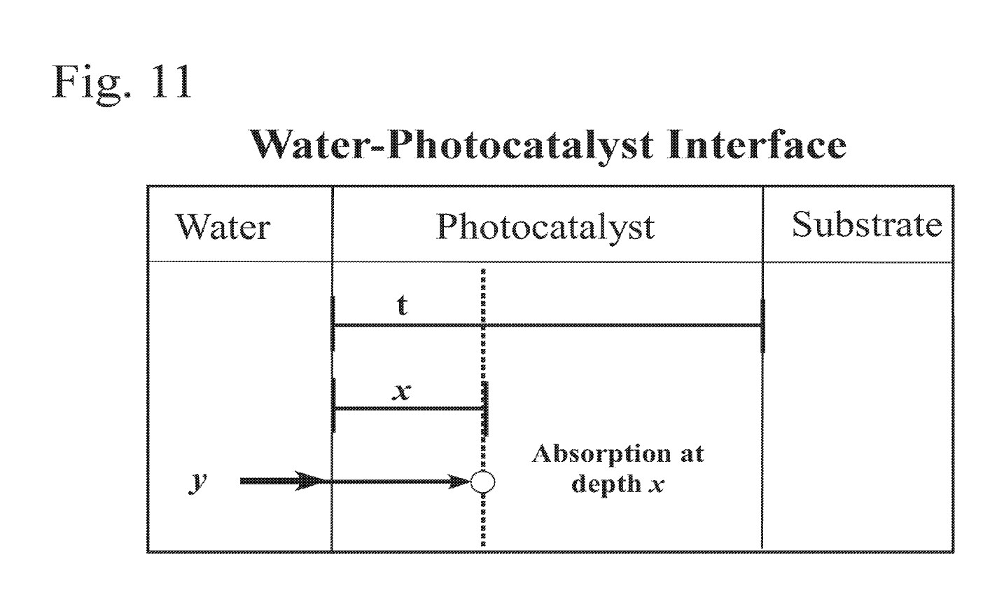

As detailed in FIG. 11, the thickness (t) of the thin-film is of great importance for optimizing the quantum yield for the reaction. As implied by FIG. 11, the average distance that a photo-stimulated electronhole pair must travel becomes greater as t increases. However thinner films result in less overall light absorption.

Method

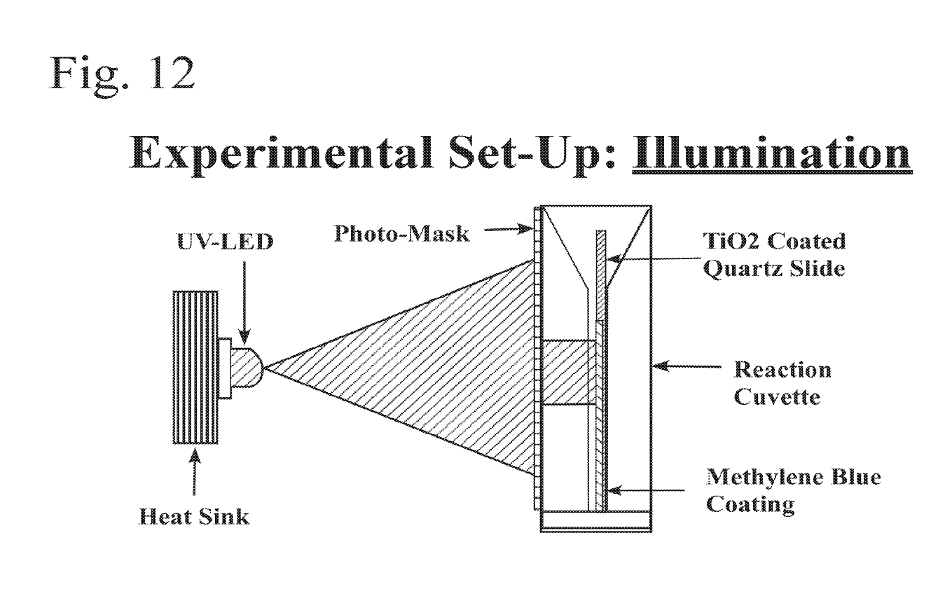

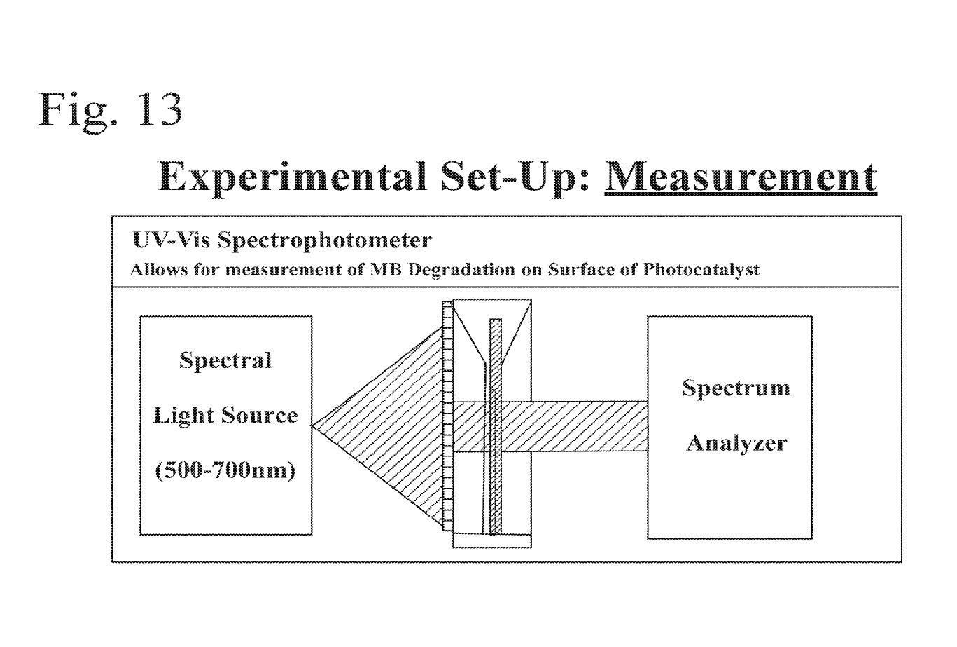

In order to determine the ideal thickness, it is necessary to analyze both the optical and electrical properties of the film. To do this a small apparatus was built that allows for quantification of UV attenuation, as well as the photodegradation rate of a film (see experimental set up in FIGS. 12 and 13).

A customized quartz slide and cuvette system was created so that the degradation of an organic marker, Methylene Blue (MB), can be observed. Before illumination with UV light, the TiO₂ coated slide was dipped into a water-MB solution, so that MB molecules would adsorb to the TiO₂ surface. The slide was then placed into the reaction cuvette and illuminated as in FIG. 12. After every minute of illumination, the amount of MB remaining on the surface is determined by measuring the absorption spectrum. This is done very simply, by removing the cuvette from the illumination apparatus, and placing directly into the cuvette holder of a spectrophotometer. Measurements were made using a Shimadzu UV-Vis 3600 Spectrophotometer (see FIG. 13).

Results

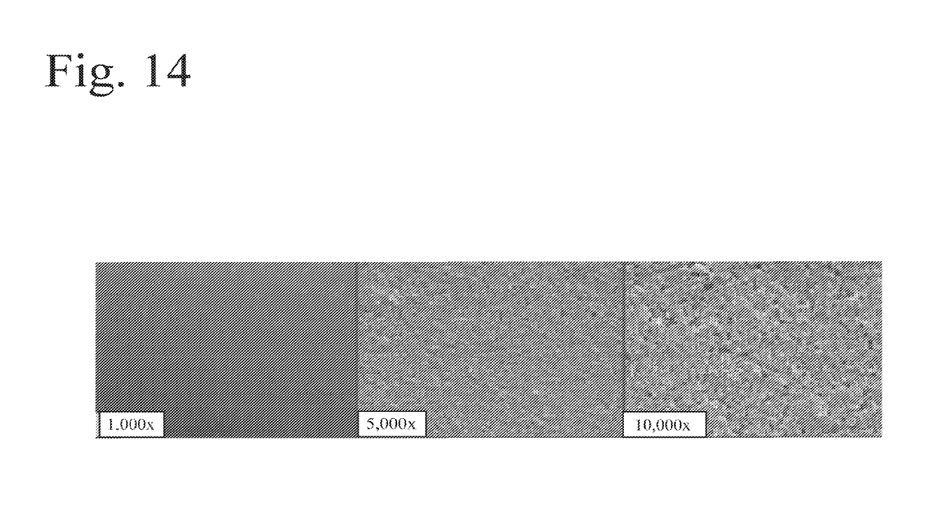

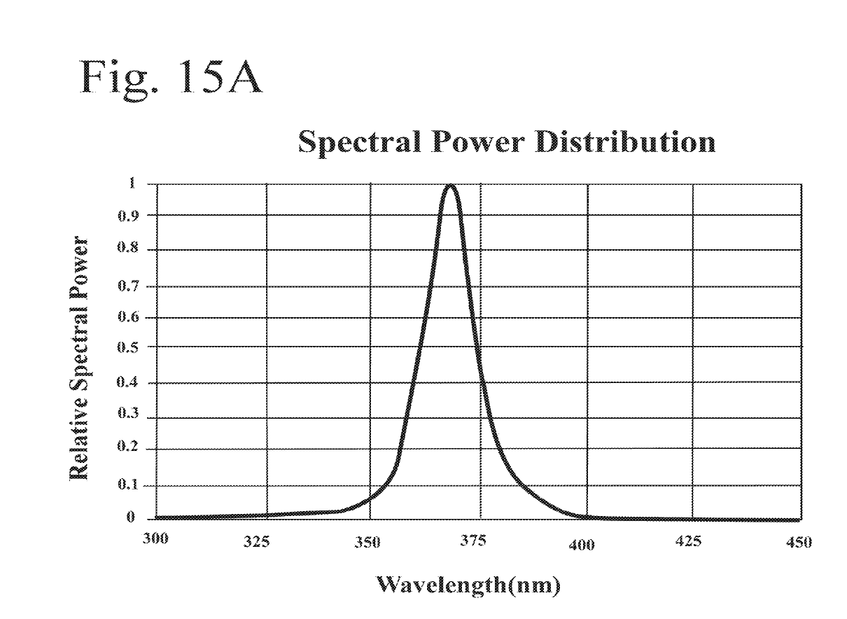

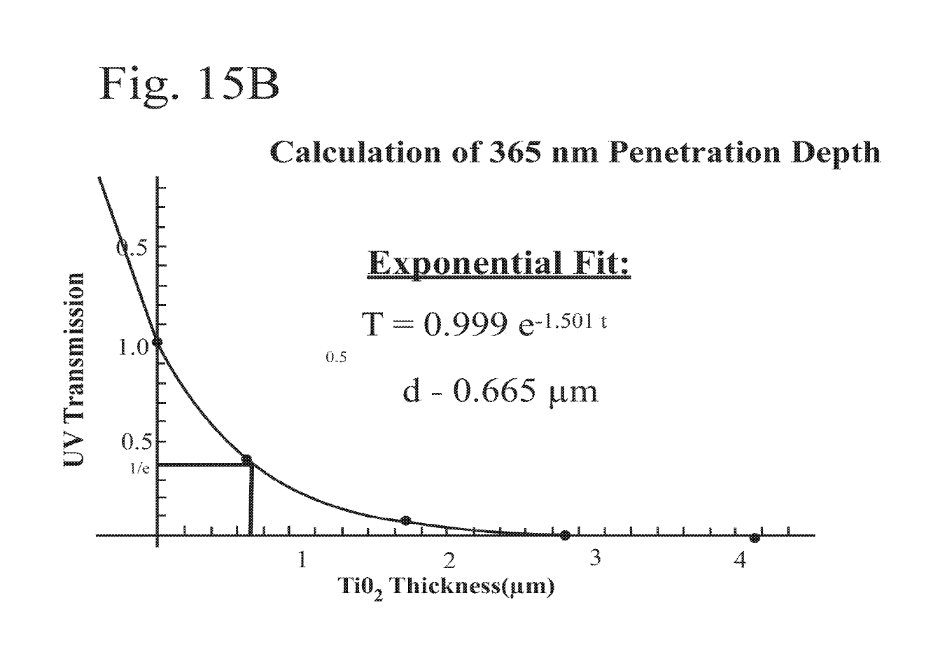

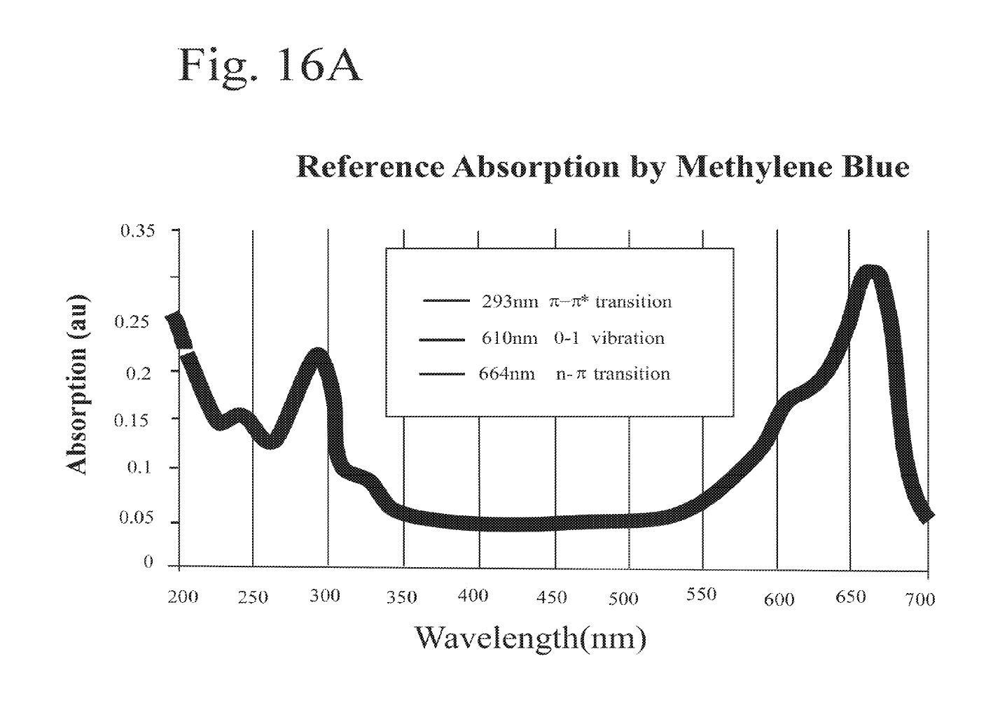

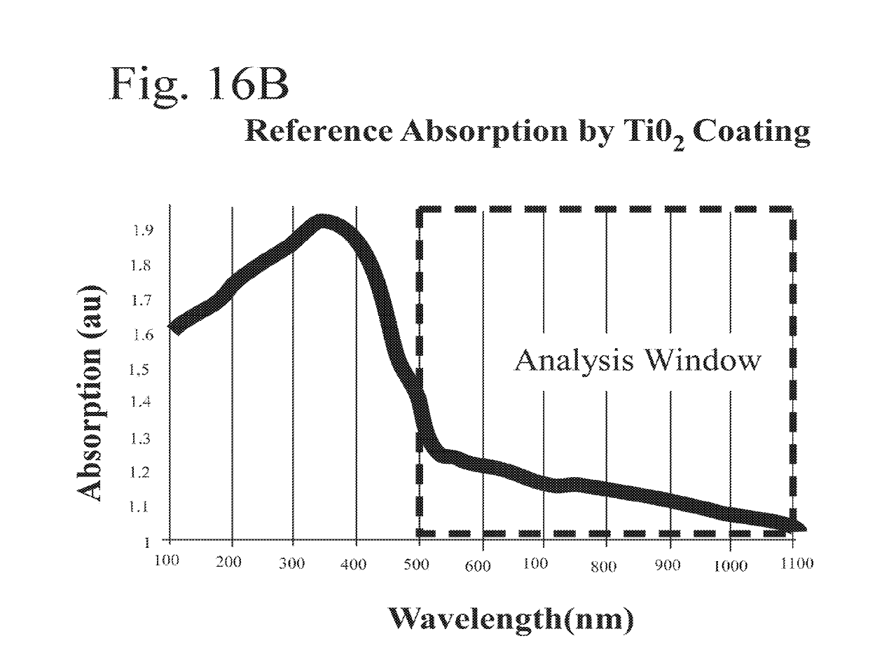

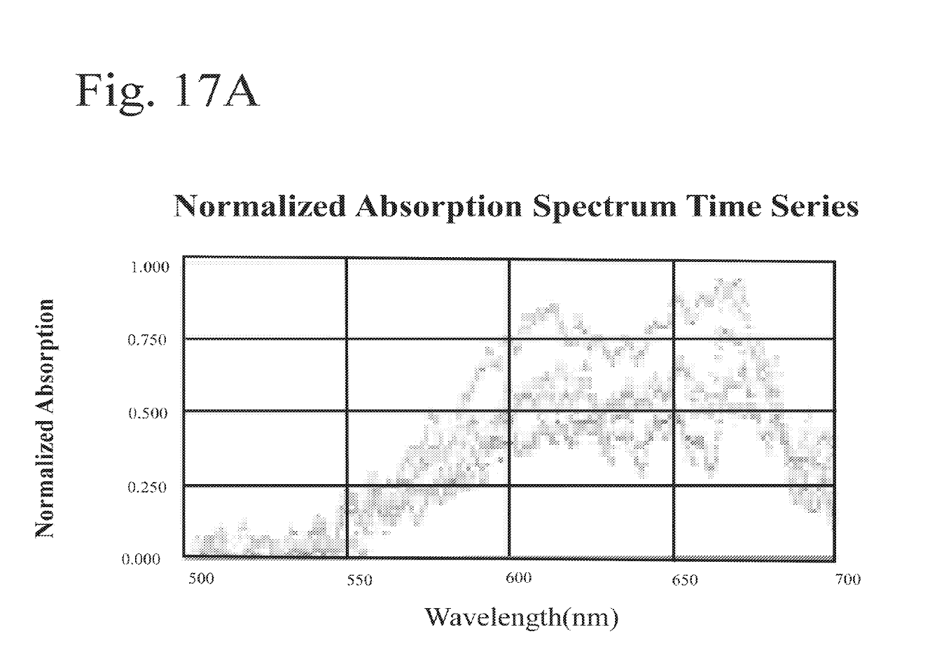

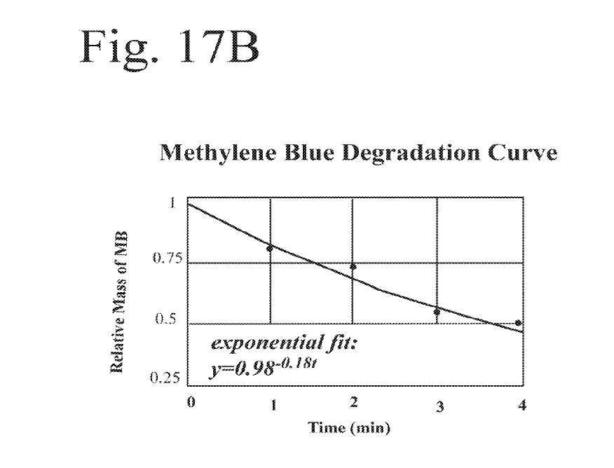

Quartz slides were coated with a thin film of TiO₂ particles via a dip coating process, and then sintered to achieve a uniform and dense coating. SEM images of the coating are shown in FIG. 14. The LED emission spectrum and the TiO₂ penetration depth of 365 nm light (peak emission value) are shown below in FIGS. 15A and 15B respectively. UV-Vis reference spectrums from 200-700 nm were collected for MB and the TiO₂ coated slide, and are shown in FIGS. 16A and 16B respectively. Data is shown in FIG. 17A along with a calculated decay constant of 0.18 (FIG. 17B) for the relative mass of MB as a function of time.

### DISCUSSION

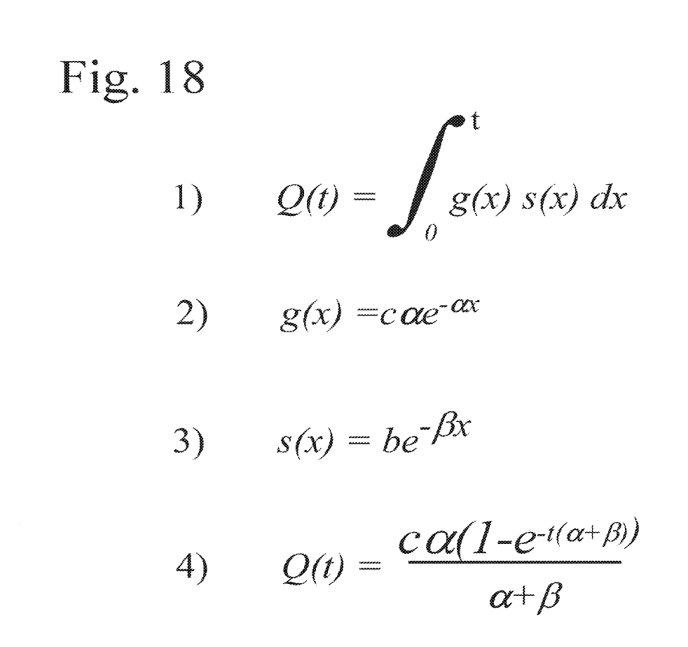

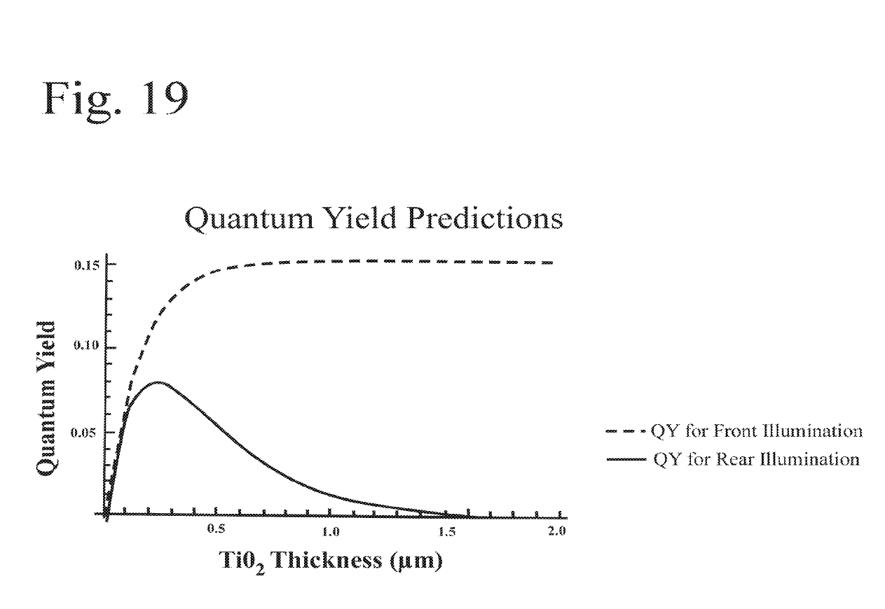

The direct measurements acquired are useful in their own right, but can a be even more useful when used in combination the equations shown in FIG. 18, which were derived to quantify the Quantum Yield (Q) as a function of thickness (see FIG. 19). The optical function g(x) and the electrical function s(x) can be obtained from the UV attenuation data and degradation data, respectively. The result from this calculation is a prediction for the optimal thickness value for maximizing the efficiency of the degradation reaction, which agrees well with empirical results.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

1. A continuous flow water purification photoreactor, comprising:
a water inlet;
a plurality of illumination sources disposed about a central axis facing and having n-fold rotational symmetry about the central axis, where n is a whole number;
a reaction tube comprising:
a set of bundled rods having m×n-fold symmetry, where m is a rational number and wherein the bundled rods comprise a photocatalyst support material at least partially coated with a photocatalyst film; and
a water outlet, wherein the water inlet is fluidly coupled to a proximal end of the reaction tube and the water outlet is fluidly coupled to a distal end of the reaction tube.

2. The continuous flow water purification photoreactor of claim 1, further comprising a housing.

3. The continuous flow water purification photoreactor of claim 1, wherein the illumination sources comprise LEDs emitting in a UV range.

4. The continuous flow water purification photoreactor of claim 1, wherein the photocatalyst support material comprises quartz and/or fused silica.

5. The continuous flow water purification photoreactor of claim 1, wherein the photocatalyst support material is porous allowing water to pass through.

6. The continuous flow water purification photoreactor of claim 1, wherein the photocatalyst comprises TiO₂

7. A water purification system, comprising a continuous flow water purification photoreactor coupled to a water source, the continuous flow water purification photoreactor, comprising:
a water inlet;
a plurality of illumination sources disposed about a central axis facing and having n-fold rotational symmetry about the central axis, where n is a whole number;
a reaction tube comprising:
a set of bundled rods having m×n-fold symmetry, where m is a rational number and wherein the bundled rods comprise a photocatalyst support material at least partially coated with a photocatalyst film; and
a water outlet, wherein the water inlet is fluidly coupled to a proximal end of the reaction tube and the water outlet is fluidly coupled to a distal end of the reaction tube.

8. The water purification system of claim 7, further comprising a housing.

9. The water purification system of claim 7, wherein the illumination sources comprise LEDs emitting in a UV range.

10. The water purification system of claim 7, wherein the photocatalyst support material comprises quartz and/or fused silica.

11. The water purification system of claim 7, wherein the photocatalyst support material is porous allowing water to pass through.

12. The water purification system of claim 7, wherein the photocatalyst comprises TiO₂

13. A method of purifying water, comprising passing the water to be purified through a continuous flow water purification photoreactor, the continuous flow water purification photoreactor, comprising:
a water inlet;
a plurality of illumination sources disposed about a central axis facing and having n-fold rotational symmetry about the central axis, where n is a whole number;
a reaction tube comprising:
a set of bundled rods having m×n-fold symmetry, where m is a rational number and wherein the bundled rods comprise a photocatalyst support material at least partially coated with a photocatalyst film; and
a water outlet, wherein the water inlet is fluidly coupled to a proximal end of the reaction tube and the water outlet is fluidly coupled to a distal end of the reaction tube.

14. The method of claim 13, further comprising a housing.

15. The method of claim 13, wherein the illumination sources comprise LEDs emitting in a UV range.

16. The method of claim 13, wherein the photocatalyst support material comprises quartz and/or fused silica.

17. The method of claim 13, wherein the photocatalyst support material is porous allowing water to pass through.

18. The method of claim 13, wherein the photocatalyst comprises TiO₂

19. A photoreactor cartridge, comprising:
a reaction tube comprising:
a distal end,
a proximal end
a set of bundled rods disposed between the distal and end and the proximal end and having m×n-fold symmetry, where m is a rational number, n is a whole number and wherein the bundled rods comprise a photocatalyst support material at least partially coated with a photocatalyst film.

20. The photoreactor cartridge of claim 19, wherein the photocatalyst support material comprises quartz and/or fused silica.

21. The photoreactor cartridge of claim 19, wherein the photocatalyst support material is porous allowing water to pass through.

22. The photoreactor cartridge of claim 19, wherein the photocatalyst comprises TiO₂
